(19) United States
(12) Patent Application Publication
(10) Pub. No.: US 2013/0283387 A1
(43) Pub. Date: Oct. 24, 2013

(54) METHOD FOR DATA SECURITY AND ELECTRONIC DEVICE HAVING DATA SECURITY FUNCTION

(71) Applicant: PENG WANG, Shenzhen City (CN)

(72) Inventor: PENG WANG, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/584,763

(22) Filed: Aug. 13, 2012

(30) Foreign Application Priority Data
Apr. 19, 2012 (CN) 201210116027.8

(51) Int. Cl. G06F 21/24; G06F 21/00

(52) U.S. Cl. 726/26

(57) ABSTRACT

In a computerized icon management method for data security of an electronic device, target data of the electronic device is defined, and an activation message corresponding to the target data is set. The target data is hidden by changing a visible state of an icon of the target data on a display of the electronic device from visible to invisible. An input interface is displayed for receiving the activation message input by a user. The visible state of the icon of the target data is changed from invisible to visible, when the activation message corresponding to the target data is input by the user through the input interface.

### BACKGROUND

1. Technical Field

Embodiments of the present disclosure relate generally to data security, and particularly to a method for data security of an electronic device.

2. Description of Related Art

Electronic devices, such as mobile phones and personal digital assistants (PDA), may be used to store personal data, which may be encrypted for data security. However, icons of the personal data may still be viewable even if the personal data is encrypted. Therefore, there is room for improvement in the art.

### BRIEF DESCRIPTION OF THE DRAWINGS

FIG. 1 is a schematic block diagram of an exemplary embodiment of an electronic device including a data security system.

FIG. 2 is a schematic diagram illustrating one example of an input interface displayed on a home screen of the electronic device of FIG. 1.

FIG. 3 is a flowchart of one embodiment of a method for data security of the electronic device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one”.

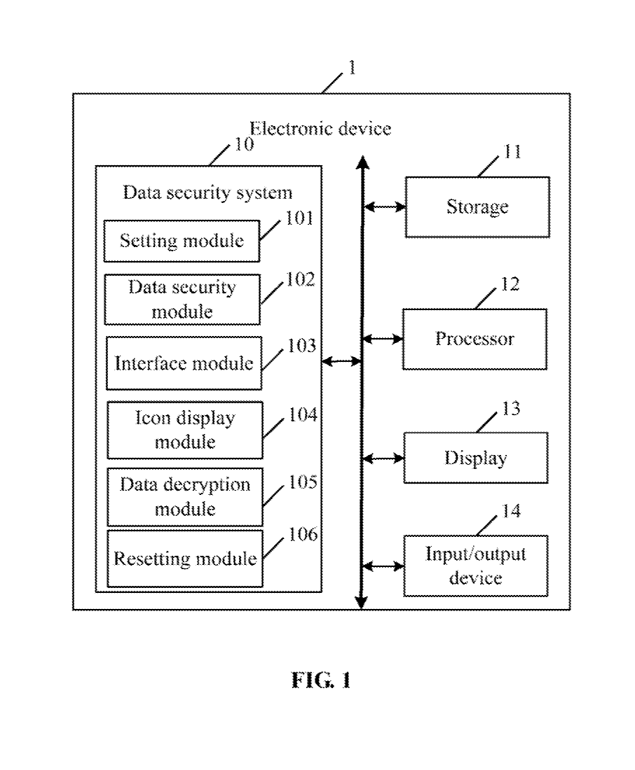

FIG. 1 is a schematic block diagram of an exemplary embodiment of an electronic device 1 including a data security system 10. The electronic device 1 further includes a storage 11, a processor 12, a display 13, and an input/output device 14. In one embodiment, the electronic device 1 may be, for example, a smart phone, a mobile internet device, or other similar devices. FIG. 1 is one example of the electronic device 1, and the electronic device 1 can include more or fewer components than those shown in the embodiment, or have a different configuration of the components.

The data security system 10 may include a plurality of programs in the form of one or more computerized instructions stored in the storage 11 and executed by the processor 12 to perform operations of the electronic device 1. In the embodiment, the data security system 10 includes a setting module 101, a data security module 102, an interface module 103, an icon display module 104, a data decryption module 105, and a resetting module 106. In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

Target data of the electronic device 1 is defined by a user. The target data may be private or confidential data stored in the electronic device 1. An activation message corresponding to the target data may be set by the setting module 101. In the embodiment, the activation message may be a text message (e.g., a data name of the target data) determined by a user. The activation message may be used to activate the target data after the target data is hidden as follows. In the embodiment, the user may select any data from the electronic device 1 through the setting module 101 according to requirements, and the selected data is defined as the target data. For example, the setting module 10 may display an interface on the display 13 and guides the user to select the target data using the displayed interface.

The data security module 102 hides the target data, and encrypts the target data. In the embodiment, the target data may be hidden by changing a visible state of an icon of the target data on the display 13 from visible to invisible. The data security module 102 may use the activation message as a password to encrypt the target data. In another embodiment, the data security module 102 may use any other preset password to encrypt the target data.

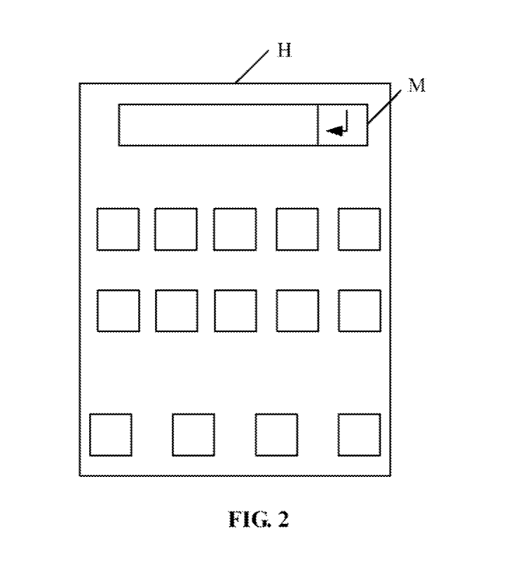

The interface module 103 displays an input interface on the display 13, and receives the activation message corresponding to the target data input by the user through the input interface. In one example, as shown in FIG. 2, the input interface (M) may be embedded in a home screen (H) displayed on the display 13. The icon of the hidden target data is not displayed on the display 13 unless the activation message corresponding to the target data is input through the input interface. The user can operate the input interface M and input information through the input interface M.

The icon display module 104 activates a directory of the electronic device 1 where the target data is stored, and changes the visible state of the icon of the target data on the display 13 from invisible to visible, when the activation message corresponding to the target data is input by the user through the input interface. In the embodiment, the user can input the activation message using the input/output device 14 through the input interface at any time when the user wants to see the hidden target data.

The data decryption module 105 decrypts the target data when the icon of the target data is operated, and displays the decrypted target data on the display 13. In the embodiment, if the target data is encrypted using the set activation message, the data decryption module 105 may automatically decrypt the target data according to the activation message input by the user. If the target data is encrypted using the preset password, the data decryption module 105 may first notify the user to input a password, and decrypts the target data according to the password input by the user.

In other embodiments, the target data may be manually unhidden and decrypted according to user requirements, for example, when the user forgets the activation message to activate the icon of the target data and the password to decrypt the target data. In the embodiment, when a predetermined verification message is input by the user through the input/output device 14, the resetting module 106 may unhide and decrypt the target data. In the embodiment, when the verification message is input by the user, the resetting module 106 unhides and decrypts the target data by clearing the activation message corresponding to the target data and the password used to encrypt the target data from the storage 11 of the electronic device 1, and then displays the icon of the target data on the display 13.

The predetermined verification message may be a fingerprint, a voiceprint, or a facial image preset by the user of the electronic device 1. Accordingly, the input/output device 14 may include at least one of a fingerprint input device (e.g., fingerprint sensor), a voice input device (e.g., a microphone), and an image capturing device. Additionally, the resetting module 106 may display a resetting button on the input interface, and the user can input the verification message using the input/output device 14 after operating the resetting button.

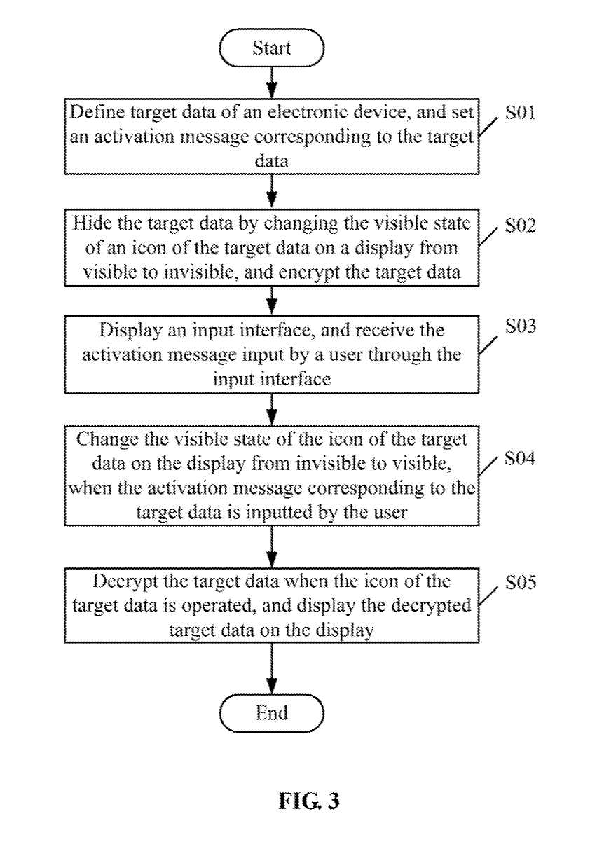

FIG. 3 is a flowchart of one embodiment of a method for data security of the electronic device 1 of FIG. 1. Depending on the embodiment, additional steps may be added, others removed, and the ordering of the steps may be changed.

In step S01, the setting module 101 defines target data of the electronic device 1, and sets an activation message corresponding to the target data. In the embodiment, the target data may be any data stored in the electronic device 1, such as private or confidential data.

In step S02, the data security module 102 hides the target data by changing a visible state of an icon of the target data on a display 13 of the electronic device 1 from visible to invisible, and encrypts the target data. In the embodiment, the target data may be encrypted using the activation message or a preset password as described above.

In step S03, the interface module 103 displays an input interface on the display 13, and receives the activation message corresponding to the target data input by the user through the input interface.

In step S04, the icon display module 104 activates a directory of the electronic device 1 where the target data is stored, and displays the icon of the hidden target data on the display 13, when the activation message corresponding to the target data is input by the user through the input interface. In the embodiment, the user can input the activation message using the input/output device 14 through the input interface at any time when the user wants to see the hidden target data.

In step S05, the data decryption module 105 decrypts the target data when the icon of the target data is operated, and displays the decrypted target data on the display 13. In the embodiment, the target data may be decrypted according to the activation message or a preset password input by the user as described above.

In other embodiments, the target data may be manually unhidden and decrypted according to user requirements. In the embodiment, when a predetermined verification message is input by the user through the input/output device 14, the resetting module 106 unhides and decrypts the target data, and displays the icon of the target data on the display 13 of the electronic device 1.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computerized method of an electronic device, the method comprising:
defining target data of the electronic device;
setting an activation message corresponding to the target data;
hiding the target data by changing a visible state of an icon of the target data on a display of the electronic device from visible to invisible;
displaying an input interface on the display, and receiving the activation message corresponding to the target data input by a user through the input interface; and
changing the visible state of the icon of the target data on the display from invisible to visible, when the activation message corresponding to the target data is input by the user.

2. The method according to claim 1, wherein the hiding step comprises:
encrypting the target data.

3. The method according to claim 2, further comprising:
decrypting the target data when the icon of the target data is operated, and displaying the decrypted target data on the display.

4. The method according to claim 3, wherein the encrypting step comprises:
encrypting the target data using the set activation message.

5. The method according to claim 4, wherein the decrypting step comprises:
decrypting the target data according to the activation message input by the user through the input interface.

6. The method according to claim 3, wherein the encrypting step comprises:
encrypting the target data using a preset password.

7. The method according to claim 6, wherein the decrypting step comprises:
notifying the user to input a password, and decrypting the target data according to the password input by the user.

8. The method according to claim 2, further comprising:
unhiding and decrypting the target data, and displaying the icon of the target data on the display of the electronic device, when a predetermined verification message is input by the user through an input/output device of the electronic device.

9. The method according to claim 8, wherein the unhiding step further comprises:
displaying a resetting button on the input interface; and
receiving the verification message input by the user through the input/output device when the resetting button is operated.

10. The method according to claim 8, wherein the verification message is a fingerprint, a voiceprint, or a facial image preset by the user of the electronic device.

11. An electronic device, comprising:
a display;
a storage;
a processor; and
one or more programs stored in the storage and executed by the processor, the one or more programs comprising:
a setting module that defines target data of the electronic device, and sets an activation message corresponding to the target data;
a data security module that hides the target data by changing a visible state of an icon of the target data on the display from visible to invisible;
an interface module that displays an input interface on the display, and receives the activation message corresponding to the target data input by a user through the input interface; and
an icon display module that changes a visible state of the icon of the target data on the display from invisible to visible, when the activation message corresponding to the target data is input by the user.

12. The electronic device according to claim 11, wherein the data security module further encrypts the target data.

13. The electronic device according to claim 12, wherein the one or more programs further comprise:
a data decryption module that decrypts the target data when the icon of the target data is operated, and displays the decrypted target data on the display.

14. The electronic device according to claim 13, wherein the data security module encrypts the target data using the set activation message.

15. The electronic device according to claim 14, wherein the data decryption module decrypts the target data according to the activation message input by the user through the input interface.

16. The electronic device according to claim 13, wherein the data security module encrypts the target data using a preset password.

17. The electronic device according to claim 16, wherein the data decryption module notifies the user to input a password and decrypts the target data according to the password input by the user.

18. The electronic device according to claim 12, wherein the one or more programs further comprise:
a resetting module that unhides and decrypts the target data, and displays the icon of the target data on the display, when a predetermined verification message is input by the user through an input/output device of the electronic device.

19. The electronic device according to claim 18, wherein the resetting module further displays a resetting button on the input interface, and receives the verification message input by the user through the input/output device when the resetting button is operated.

20. The electronic device according to claim 18, wherein the verification message is a fingerprint, a voiceprint, or a facial image preset by the user of the electronic device.
